(19) United States
(12) Patent Application Publication
(10) Pub. No.: US 2006/0134372 A1
(43) Pub. Date: Jun. 22, 2006

(54) Fragment and work formed by assembling the fragments

(75) Inventor: Yue-Sue Hsu, Taipei (TW)

Correspondence Address: BACON & THOMAS, PLLC, 625 SLATERS LANE, FOURTH FLOOR, ALEXANDRIA, VA, 22314, US

(73) Assignee: TAIWAN HONG YEE CORPORATION, TAIPEI (TW)

(21) Appl. No.: 11/012,247

(22) Filed: Dec. 16, 2004

(51) Int. Cl. B32B 3/02

(52) U.S. Cl. 428/81

(57) ABSTRACT

The present invention is to provide a fragment comprising a body, a plurality of projections formed along a peripheral edge of the body and a plurality of cavities each formed between the projection and the body, wherein each of the cavities is adapted to matingly couple to a cavity of another identical fragment for engaging one projection with the body or the other projection, thereby enabling the fragments to be assembled to form the work by means of an assembly of the fragments.

### FIELD OF THE INVENTION

The present invention relates to a fragment and a work formed by assembling a plurality of fragments, more particularly to a fragment capable of being bent and matingly coupled with the other, thereby assembling the fragments to form a work.

### BACKGROUND OF THE INVENTION

Conventionally, a thing (e.g., stone, timber, cast iron, etc.) can be used as a material for sculpture. Moreover, a work can be formed by assembling a plurality of fragments. Such is disclosed in Taiwanese Patent Publication No. 345,118 (hereinafter called the Patent) as shown in FIG. 1 and is characterized as follows. A work is formed by assembling a plurality of folded paper fragments 30. The work has one of a variety of shapes by selecting one of a plurality of different assembling methods and forms. Eventually, a work having a specialized form or shape can be produced.

As stated above, the work is formed by assembling a plurality of folded paper fragments 30 in which the fragments 30 are prefabricated. The prior fragment 30 is made of paper. In detail, a paper sheet of suitable size is selected. Next, fold the sheet along its central transverse line. Next, fold the sheet again along its central longitudinal line. Next, fold a portion of the sheet projected from one side to the other side so as to form a substantially triangular, three dimensional member which is adapted to assemble with one or more the same members to form a work having a desired shape.

While the above paper work is aesthetic, its forming process is very tedious and time consuming since the fragments 30 are required to fold prior to assembly. Moreover, the paper work is susceptible to moisture, resulting in damage. In addition, mass production is impossible since respective fragments 30 are folded prior to assembly. In other words, the production time is adversely prolonged. As a result, the manufacturing cost is increased significantly in consideration of high pay today. Additionally, one formed fragment 30 may be different from any other ones since skills of all involved workers are not the same. This in turn can degrade quality of the formed work, thereby lowering the desire of buying it by mass consumers.

The Patent is further characterized as follows. A fragment is formed by injection molding. The fragment consists of two identical triangular sheaths with a connecting piece and a cavity formed therebetween for enabling the fragment to put on one or more other fragments so as to form a work having a desired shape. Such fragments can be produced in mass scale by an automatic machine, resulting in a simplification of the manufacturing processes, a shortening of the manufacturing time, and a reduction in the manufacturing cost.

However, injection molding is the only best method as conceived by the Patent. This inevitably prohibits the Patent from utilizing any other cheaper and/or quicker processes in manufacturing the fragments. Also, one fragment is permitted to assemble with another identical one only, resulting in a limitation of the assembly variation. Moreover, the sheaths are coupled together by a connecting piece. As such, the fragment is useless if the connecting piece is broken. Thus, it is desirable to provide a novel fragment not only having the advantages of the Patent but also being capable of overcoming the above drawbacks thereof.

### SUMMARY OF THE INVENTION

After considerable research and experimentation, a fragment and a work formed by assembling the fragments according to the present invention has been devised so as to overcome the above drawbacks of the prior art.

It is an object of the present invention to provide a fragment comprising a body; a plurality of projections formed along a peripheral edge of the body; and a plurality of cavities each formed between the projection and the body, wherein each of the cavities is adapted to matingly couple to a cavity of another identical fragment for engaging one projection with the body or the other projection, thereby assembling the fragments.

It is another object of the present invention to provide a work formed by assembling a plurality of fragments each comprising a body; a plurality of projections formed along a peripheral edge of the body; and a plurality of cavities each formed between the projection and the body, wherein each of the cavities is adapted to matingly couple to a cavity of another identical fragment for engaging one projection with the body or the other projection, thereby forming the work by means of an assembly of the fragments.

It is yet another object of the present invention to provide a light-emitting unit on the body of one of the fragments of the work such that a dazzling effect can be seen on the work when the light-emitting unit emits light.

It is a further object of the present invention to print a portion of a picture to be seen on the work on one of the fragments in advance so as to re-form the picture of the work by assembling the fragments.

The above and other objects, features and advantages of the present invention will become apparent from the following detailed description taken with the accompanying drawings.

### BRIEF DESCRIPTION OF THE DRAWINGS

FIG. 1 is a perspective view of a conventional fragment;

FIG. 2 is a plan view of a fragment according to the invention;

FIG. 3 is a perspective view of a work formed by assembling the fragments of FIG. 2 and coupled to a base in a first preferred embodiment according to the invention;

FIG. 4 is a view similar to FIG. 3 showing a second preferred embodiment according to the invention; and

FIG. 5 is a perspective view of the fragment of FIG. 2 with a light-emitting unit mounted thereon in a third preferred embodiment according to the invention.

### DETAILED DESCRIPTION OF THE PREFERRED EMBODIMENTS

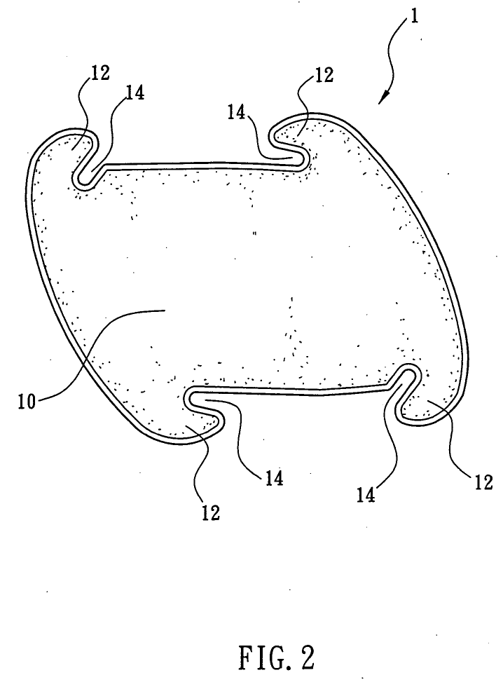

Referring to FIG. 2, there is shown a fragment and a work formed by assembling the fragments in accordance with the invention. The fragment 1 comprises a body 10, a plurality of projections 12 formed along its peripheral edge, and a plurality of cavities 14 each formed between the projection 12 and the body 10. The cavity 14 is adapted to matingly couple to a cavity 14 of another identical fragment 1 so as to engage the projection 12 with the body 10 or another projection 12, resulting in an assembly of the fragments 1.

In the invention, the body 10 is substantially rectangular. The projections 12 are formed at four corners of the body 10. The projections 12 at both ends of either diagonal of the body 10 are identical in shape. A free end of any projection 12 of the body 10 is not only proximate and facing the same of an adjacent one at one side but also distal and opposing the same of another adjacent one at the other side.

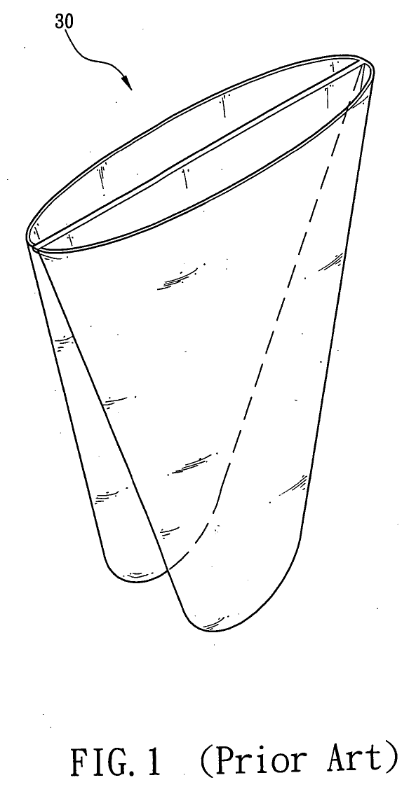

In the invention, the fragment 1 is formed of a flexible and pliable material. For example, the fragment 1 is of plastic and formed by injection molding. Alternatively, the fragment 1 is formed of a flexible and pliable metal or alloy. For example, the fragment 1 is formed by casting, cutting, punching, or the like. In view of above, the fragment 1 can be quickly produced in mass scale, modularly by one of a plurality of processes. Further, its material is not limited to plastic. This is an improvement of the prior fragment 30 (see FIG. 1) which is of plastic and formed by injection molding only. Moreover, words, pictures, or colors may be formed on the fragment 1 such that a fragment having desired words, pictures, or colors can be produced.

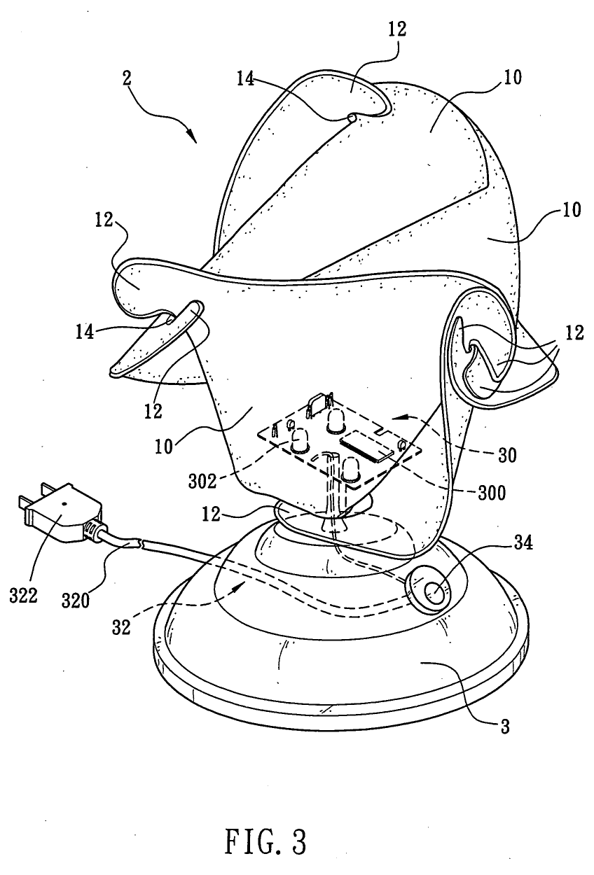

Referring to FIG. 3, there is shown a work formed by assembling the fragments 1. The work is formed by assembling a plurality of fragments 1. The fragment 1 comprises a body 10, a plurality of projections 12 formed along its peripheral edge, and a plurality of cavities 14 each formed between the projection 12 and the body 10. The cavity 14 is adapted to matingly couple to a cavity 14 of another identical fragment 1 so as to engage the projection 12 with the body 10 or another projection 12, thereby forming a work 2 by assembling the fragments 1.

In a first preferred embodiment of the invention, the work 2 is further adapted to couple to a base 3. A control circuit 30 is mounted proximate one end of the work 2 coupled to the base 3. The control circuit 30 is enclosed by the work 2 and is comprised of a plurality of electronic elements 300 and at least one light-emitting element 302. The electronic elements 300 are adapted to convert power supplied from an external source into an operating voltage of the light-emitting element 302. Light emitted by the light-emitting elements 302 is thus controlled. Within the base 3 there are further provided a power supply 32 including a power cord 320 having one end coupled to the control circuit 30 and the other end coupled to a plug 322. In response to plugging the power cord 320 into a wall outlet, external current can be taken to the control circuit 30 via the power cord 320. The current is then converted into an operating voltage of the light-emitting elements 302 by the control circuit 30. There is further provided a switch 34 interconnected the power cord 320 and the control circuit 30 for enabling a user to turn on or off the external current supplied to the control circuit 30. Finally, a dazzling effect can be seen on the work 2 when the light-emitting elements 302 emit light.

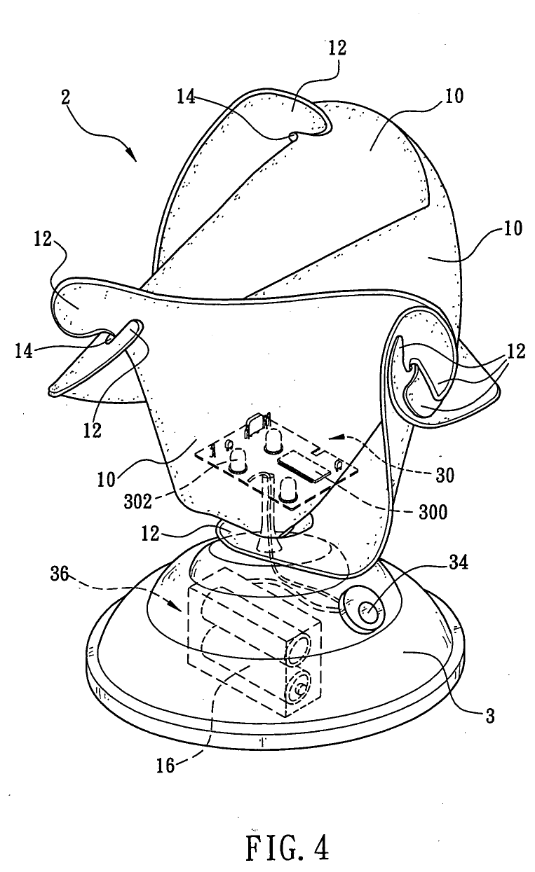

Referring to FIG. 4 in conjunction with FIG. 3, there is shown a second preferred embodiment of the invention. The second preferred embodiment substantially has same structure as the first preferred embodiment. The differences between the first and the second preferred embodiments, i.e., the characteristics of the second preferred embodiment are detailed below. There is no provision of power supply 32. Instead, there is provided a battery compartment 36 having at least one cell 16 (two are shown) contained therein for supplying power to the control circuit 30. The switch 34 is interconnected the battery compartment 36 and the control circuit 30 for enabling a user to turn on or off the power supplied from the cells 16 in the battery compartment 36 to the control circuit 30.

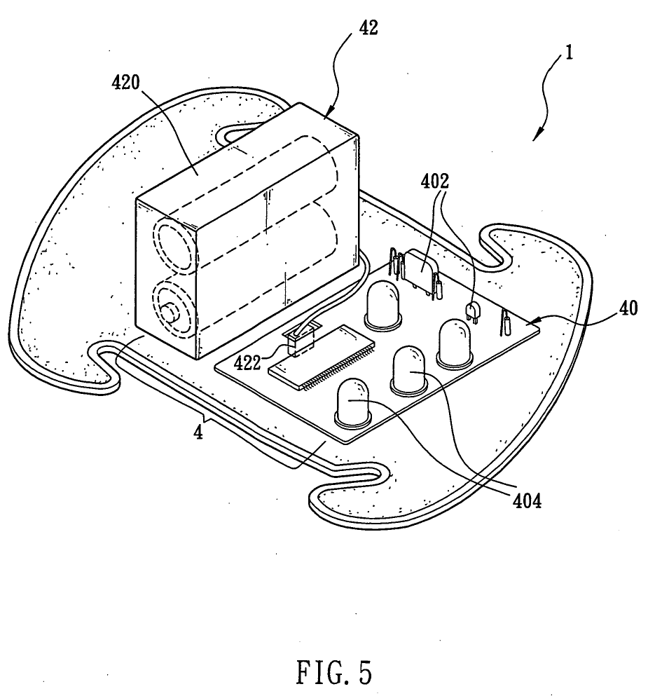

Referring to FIG. 5, there is shown a third preferred embodiment of the invention. A light-emitting unit 4 is provided on the body 10 of one fragment 1 of the work 2. The light-emitting unit 4 comprises a control circuit 40 and a battery compartment 42. A plurality of electronic elements (e.g., resistors, capacitors, transistors, chips, etc.) 402 and at least one light-emitting element (two are shown e.g., LEDs (light-emitting diodes) or bulbs) 404 are provided on the control circuit 40. The electronic elements 402 are adapted to convert power supplied from an external source into an operating voltage of the light-emitting element 404. Light emitted by the light-emitting elements 404 is thus controlled. There are further provided a battery compartment 420 and a switch 422. The battery compartment 420 has at least one cell 16 (two are shown) contained therein for supplying power to the control circuit 40. The switch 34 is interconnected the battery compartment 420 and the control circuit 40 for enabling a user to turn on or off the power supplied from the cells 16 in the battery compartment 420 to the control circuit 40. Finally, a dazzling effect can be seen on the work 2 when the light-emitting unit 4 emits light.

In any of the above embodiments, a portion of a picture to be seen on the work 2 can be printed on one of a plurality of fragments 1 of the work 2 in advance. As such, the picture of the work 2 can be re-formed by assembling the fragments 1 rather than re-forming a random meaningless one. In view of this, it is contemplated that the fragments 1 can be used as a jigsaw puzzle or the like. While the invention herein disclosed has been described by means of specific embodiments, numerous modifications and variations could be made thereto by those skilled in the art without departing from the scope and spirit of the invention set forth in the claims.

What is claimed is:

1. A fragment comprising:
a body;
a plurality of projections formed along a peripheral edge of the body; and
a plurality of cavities each formed between the projection and the body,
wherein each of the cavities is adapted to matingly couple to a cavity of another identical fragment.

2. The fragment of claim 1, wherein the body is substantially rectangular, the projections are formed at four corners of the body, the projections at both ends of either diagonal of the body are identical in shape, a free end of each of the projections of the body is proximate and facing the same of an adjacent one at one side, and a free end of each of the projections of the body is distal and opposing the same of another adjacent one at the other side.

3. The fragment of claim 1, wherein the fragment is printed with words, pictures, or colors.

4. A work formed by assembling a plurality of fragments each comprising:
a body;
a plurality of projections formed along a peripheral edge of the body; and
a plurality of cavities each formed between the projection and the body,
wherein each of the cavities is adapted to matingly couple to a cavity of another identical fragment for engaging one projection with the body or the other projection, thereby forming the work by means of an assembly of the fragments.

5. The work of claim 4, wherein the body is substantially rectangular, the projections are formed at four corners of the body, the projections at both ends of either diagonal of the body are identical in shape, a free end of each of the projections of the body is proximate and facing the same of an adjacent one at one side, and a free end of each of the projections of the body is distal and opposing the same of another adjacent one at the other side.

6. The work of claim 4, wherein the fragment is formed of a flexible and pliable material.

7. The work of claim 4, further comprising a base coupled to the work, and a control circuit mounted at one end of the work and coupled to the base, the control circuit being enclosed by the work and comprising a plurality of electronic elements and at least one light-emitting element adapted to convert power supplied from an external source into an operating voltage of the light-emitting element for controlling light emitted by the light-emitting element, wherein the base comprises a power supply including:
a power cord having one end coupled to the control circuit and the other end extended from the base;
a plug coupled to the other end of the power cord and adapted to insert into an outlet for taking an external current to the control circuit via the power cord; and
a switch disposed on an outer surface of the base and interconnected the power cord and the control circuit.

8. The work of claim 4, further comprising a base coupled to the work, and a control circuit mounted at one end of the work and coupled to the base, the control circuit being enclosed by the work and comprising a plurality of electronic elements and at least one light-emitting element adapted to convert power supplied from an external source into an operating voltage of the light-emitting element for controlling light emitted by the light-emitting element, wherein the base comprises:
a battery compartment having at least one cell for supplying power to the control circuit; and
a switch disposed on an outer surface of the base and interconnected the battery compartment and the control circuit.

9. The work of claim 4, further comprising a light-emitting unit formed on the body of one of the fragments of the work, the light-emitting unit comprising:
a control circuit including a plurality of electronic elements and at least one light-emitting element enclosed by the work wherein the light-emitting element is adapted to convert power supplied from an external source into an operating voltage of the light-emitting element for controlling light emitted by the light-emitting element; and
a battery assembly comprising:
a battery compartment having at least one cell for supplying power to the control circuit; and
a switch interconnected the battery compartment and the control circuit wherein a portion the switch is projected from the fragment having the light-emitting unit formed thereon, the switch being adapted to either turn on or turn off the external current supplied to the control circuit.

10. The work of claim 4, further comprising printing a portion of a picture to be seen on the work on one of the fragments in advance so as to re-form the picture of the work by assembling the fragments.
